(19) United States
(12) Patent Application Publication
(10) Pub. No.: US 2005/0091214 A1
(43) Pub. Date: Apr. 28, 2005

(54) Internal object protection from application programs

(75) Inventors: David B. Probert, Woodinville, WA (US); Eric Li, Redmond, WA (US); Dragos C. Sambotin, Issaquah, WA (US); Genevieve Fernandes, Bellevue, WA (US); John Austin Rector, Redmond, WA (US); Edward J. Praitis, Woodinville, WA (US); Valeriy Tsuryk, Sammamish, WA (US)

Correspondence Address: SENNIGER, POWERS, LEAVIT & ROEDEL, ONE METROPOLITAN SQUARE, 16TH FLOOR, ST. LOUIS, MO, 63102, US

(73) Assignee: Mircrosoft Corporation, Redmond, WA (US)

(21) Appl. No.: 10/938,094

(22) Filed: Sep. 10, 2004

Related U.S. Application Data
(63) Continuation-in-part of application No. 10/868,182, filed on Jun. 15, 2004.
(60) Provisional application No. 60/513,941, filed on Oct. 24, 2003.

(51) Int. Cl. G06F 7/00

(52) U.S. Cl. 707/9

(57) ABSTRACT

Granting an executable object (e.g., an application program, thread, or process) access to a namespace object (e.g., a named object, resource, file, or folder). A request by the executable object for the namespace object is intercepted and processed to determine whether a local namespace associated with the executable object, user, or session stores a copy of the requested namespace object. If the copy exists in one of the local namespaces, the request is granted and allowed to operate on that local namespace. If the requested namespace object exists only in a global namespace, the namespace object is copied to a local namespace. The request is then granted and allowed to operate on the copy of the namespace object in the local namespace. Protecting the namespace objects stored in the global namespace from modification improves the stability of the application program and operating system.

### CROSS-REFERENCE TO RELATED APPLICATION

This application is a continuation-in-part of co-pending U.S. patent application Ser. No. 10/868,182, filed Jun. 15, 2004, entitled “Operating System Resource Protection,” which claims the benefit of U.S. Provisional Application No. 60/513,941, filed Oct. 24, 2003, the entire disclosures of which are incorporated herein by reference. Filed simultaneously herewith is U.S. non-provisional patent application entitled “Identifying Dependent Files of an Application Program,” attorney docket number MS#308430.01 (5123), the entire disclosure of which is incorporated herein by reference.

### TECHNICAL FIELD

Embodiments of the present invention relate to the field of operating systems for computers. In particular, embodiments of this invention relate to managing the installation, execution, and removal of applications by an operating system.

### BACKGROUND OF THE INVENTION

While operating systems have made dramatic strides in improving their usability and reliability, the user experience relating to the installation, management, and removal (i.e., uninstallation) of application programs still needs improvement. For example, applications often require administrator privileges for installation and execution due to their operations in administrator namespaces. A namespace is a grouping of one or more names that represent individual objects within the group in a shared computing environment. Two of these namespaces include, for example, a namespace for a type of system setting (e.g., a registry) and a file system namespace. Namespace conflicts emerge with application programs creating the same names in a common global location. For example, an application program may incorrectly configure a system setting during installation or overwrite a file needed by another application program. For example, in some current operating systems, a newly installed application program may overwrite a shared dynamic-link library (DLL) file with an older or newer version needed by the newly installed application program. If the older or newer file is incompatible with the overwritten file, a currently installed application program dependent on the overwritten file may crash when attempting to access the overwritten file. In one example, applications often create registry keys or values to specify their specific configuration information such as installed components, user settings, etc. Since the certain registry keys requires administrator access for updates, the application may require administrator rights for execution so that they may update the registry keys or values. The result is often application program fragility or operating system instability. In addition, application program reliance on internal objects causes application compatibility issues and limits the innovation of the operating system.

It may also be difficult for users to uninstall undesirable applications such as ad-ware and spy-ware. Many system crashes and performance degradation (e.g., slow boot times) may also be attributable to application problems. For example, the following situations may cause an application program and possibly the underlying operating system to fail: an incomplete uninstall of an application, over-deletion when uninstalling an application program, and improperly stored files.

Accordingly, an improved system and method for managing application impact is desired to address one or more of these and other disadvantages.

### SUMMARY OF THE INVENTION

Embodiments of the invention include a method for allowing an operating system (OS) to protect its resources by isolating executable objects into separate namespaces. In an embodiment, the invention includes employing a persistent, individual identity associated with an executable object such as an application program or a group of application programs to allow an operating system to identify and differentiate between the different application programs or groups of application programs and components thereof.

In one embodiment, the system labels the internal resources with an OS application identity and identifies the operating system code to prevent non-OS code from accessing the internal resources. When non-OS code tries to directly access an internal object, the system takes the appropriate action for the access attempt. Actions might include rejecting the access, logging the access, etc.

The operating system or other program manipulates the application programs via the identities associated with each of the application programs. For example, the operating system uses the identities to (1) ensure clean uninstalls, (2) prevent an application from accessing a service or performing an action for which the application does not have authorization, (3) virtualize system resources to better isolate applications from each other, (4) enable application impact rollback (e.g., revert file type associations to a pre-application install state), and (5) enable file and registry ownership tracking. Protection mechanisms include, but are not limited to, providing read-only access, logging changes to enable rollback, and virtualizing resources per application and per user. For example, the operating system generates a copy of a write-protected file for an application program that has requested write access to the write-protected file.

The invention provides an improved application model, separating applications from the operating system resources. Isolating executable objects into separate namespaces reduces the possibility of name conflicts and unexpected changes by other executable objects.

In accordance with one aspect of the invention, a method grants a first object executing in a computing system access to a second object. The first object has a local namespace associated therewith. The method includes receiving a request from the first object to access the second object. The method also includes determining whether the second object is stored in the local namespace. The method also includes granting the first object access if the second object is determined to be stored in the local namespace. Otherwise, the method includes copying the second object from a global namespace to the local namespace and granting the first object access to the copied second object in the local namespace.

In accordance with another aspect of the invention, one or more computer-readable media have computer-executable components for granting a first object executing in a computing system access to a second object. The first object has a local namespace associated therewith. The components include an interface component for receiving a request from the first object to access the second object. The components also include an analysis component for determining whether the second object is stored in the local namespace. The components also include a security component for granting the request received by the interface component if the second object is determined by the analysis component to be stored in the local namespace. The components also include, if the second object is determined by the analysis component to be stored in a global namespace, copying the second object from the global namespace to the local namespace and granting the first object access to the copied second object in the local namespace.

In accordance with still another aspect of the invention, a system for multi-layer virtualization protects objects in a computing system. The system includes a memory area storing an ordered set of namespaces. The system also includes a processor configured to execute computer-executable instructions for receiving a request from an executable object for access to a resource object, identifying a first namespace from the ordered set of namespaces that includes the requested resource object, and providing the executable object with access to the requested resource object from the identified, first namespace.

In yet another aspect of the invention, a computerized method deprecates resource usage in a computing system. The computerized method includes detecting a predefined operation of an executable object. The predefined operation relates to access to a resource object. The method also includes redirecting the detected, predefined operation from the resource object to another resource object as a function of the executable object and the resource object.

In another aspect of the invention, a system implements a virtual view of computing system resources for an executable object. The system includes a global namespace for storing one or more namespace objects. The system also includes a local namespace associated with the executable object. The local namespace stores a copy of at least one namespace object. The system also includes a manifest for mapping each of the namespace objects stored in the global namespace to the copy stored in the local namespace.

Alternatively, the invention may comprise various other methods and apparatuses.

Other features will be in part apparent and in part pointed out hereinafter.

### BRIEF DESCRIPTION OF THE DRAWINGS

FIG. 1 is an exemplary embodiment of an operating system providing an application program with access to a resource.

FIG. 2 is an exemplary flow chart illustrating operation of an access control method through virtualizing resources.

FIG. 3 is an exemplary flow chart illustrating a mitigation architecture for protecting various resources.

FIG. 4 is an exemplary flow chart illustrating operation of a method of providing access control for files, system settings, and extensions.

FIG. 5 is an exemplary flow chart illustrating operation of a method of providing access control for system settings.

FIG. 6 is a block diagram illustrating one example of a suitable computing system environment in which the invention may be implemented.

Corresponding reference characters indicate corresponding parts throughout the drawings.

### DETAILED DESCRIPTION OF THE INVENTION

In one embodiment, the invention provides a method for protecting resources in namespaces. A namespace is a grouping of one or more names that represent individual objects within the group in a shared computing environment. Exemplary namespaces include those associated with object manager, name pipes, mail slots, and network functionality. Object manager namespaces include synchronization objects (e.g., events, mutexes, and semaphores), plug and play, devices, and other named objects. In one embodiment, network namespaces exist for ports and sockets. In particular, functionality of the operating system enables the declaration of protection for files and system settings. The declared protection is persisted and enforced by the operating system or other application program (e.g., a resource provider) through a set of actions the operating system may use during the application lifecycle to manage, track, predict, and mitigate the installation, running, servicing, and removal of application programs. Resource protection provides referential integrity of the vital system data (e.g., file associations), addresses application fragility issues to improve reliability and consistency by tracing and isolating access to resources by each application program, and manages the impact of interactions by the system and applications with protected resources. For example, embodiments of the invention may be used to provide security against applications that have been infected by a virus or a worm. Embodiments of the invention are operable with any operating system model to provide extensibility and enable integration. The resource protection strategies and implementation of embodiments of the invention also prevent an application installer from accidentally or maliciously modifying or replacing vital system resources. Embodiments of the invention (e.g., a filter driver) may be combined with other strategies for protecting system resources. For example, a computing system may implement strategies including a combination of lock down, isolation, virtualization, transaction, and sandboxing.

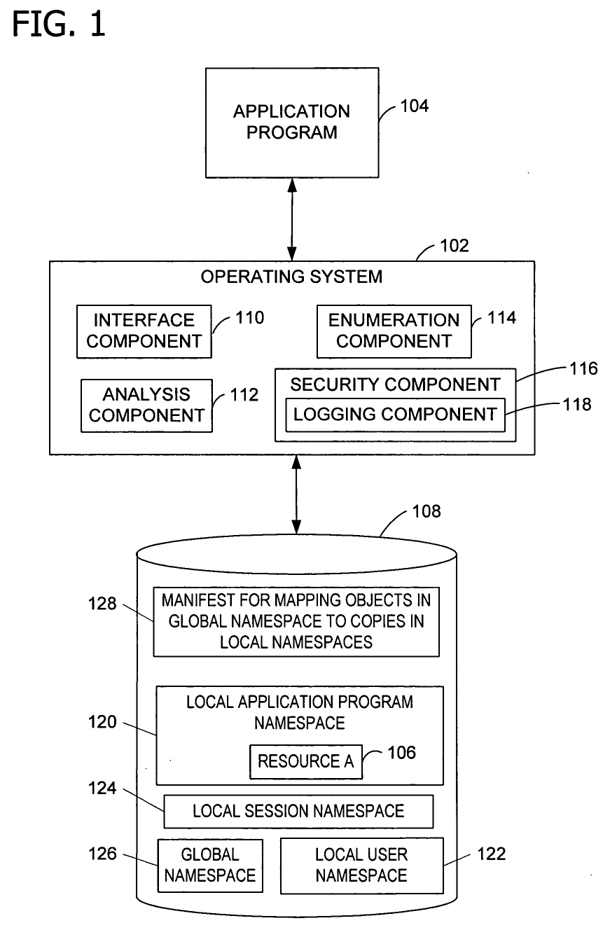

Referring first to FIG. 1, an exemplary embodiment of an operating system 102 provides an application program 104 (e.g., a first object) with access to a resource A 106 (e.g., a second object). Resource A includes, but is not limited to, one or more of a file, folder, process, thread, fiber, system setting, named object, work item, an application programming interface (API), a specific code path, a library of executable routines, operating system property value, and an operating system resource. A named object includes any object identified by alphabetic, numeric, alphanumeric, or non-human readable (e.g., a globally unique identifier) data. For example, a number of APIs and code paths provide send mail capability, and access to these APIs and code paths might be restricted. In another example, the ability to reboot the system is restricted. Resources also include the system's namespace (e.g., the ‘names’ themselves), not just specific named objects. For example, reserving or squatting on a name before an object is created with the name creates both fragility and security issues.

The operating system 102 intercepts an attempt by the application program 104 to access a resource or other namespace object such as resource A 106. The operating system 102 receives the request from application program 104 to modify resource A 106. Resource A 106 may be stored in any of the namespaces accessible to the operating system 102. In the example of FIG. 1, the operating system 102 has access to a computer-readable medium 108 storing a local application program namespace 120, a local user namespace 122, a local session namespace 124, and a global namespace 126. In one embodiment, a local namespace such as namespaces 120, 122, and 124 includes objects that may be referenced by name, identity, or address from a computer system. The global namespace 126 stores one or more namespace objects. Each local namespace 120, 122, 124 may store a copy of the one or more namespace objects stored in the global namespace 126. A manifest 128 maps each of the namespace objects stored in the global namespace 126 to a copy stored in a local namespace 120, 122, 124. The manifest 128 includes one or more of a rule, an object manifest, and an operating system manifest.

The operating system 102 determines whether resource A 106 is stored in any of the local namespaces 120, 122, 124 on computer-readable medium 108. The operating system 102 grants the received request in this example as resource A 106 is stored in the local application program namespace 120. However, in another example (not shown), resource A 106 may not be present in any of the local namespaces 120, 122, 124. In such an example, the operating system copies resource A 106 from the global namespace 126 to one of the local namespaces 120, 122, 124 and grants application program 104 access to modify the copied resource A 106 in that local namespace. Future requests for resource A 106 by application program 104 are serviced from that local namespace storing the copy of resource A 106.

In one embodiment, the operating system 102 stores or has access to one or more computer-executable components on a computer-readable media. In general, a processor associated with the operating system 102 is configured to execute the computer-executable components or other computer-executable instructions to detect a predefined operation of an executable object (e.g., application program 104). The processor is further configured to execute computer-executable instructions to redirect the detected predefined operation from the resource object (e.g., resource A 106) to another resource object (e.g., in a local namespace) as a function of the executable object and the resource object.

In particular, the computer-executable components control access by the application program 104 to resource A 106. In FIG. 1, the components include an interface component 110, an analysis component 112, a security component 116 (with a logging component 118), and an enumeration component 114. The components in FIG. 1 may exist separate from and independent of the operating system 102. Further, the functionality and structure of embodiments of the invention may be organized into any quantity of modules, components, or the like. For example, the modules may be distributed.

The interface component 110 receives a request from the first object to modify the second object. The logging component 118 stores information about the request received by the interface component 110 in a log (e.g., a file). In one embodiment, the logging component 118 logs application behavior to identify possible application compatibility issues or lack thereof. Logging can also be used to detect successful system attacks (e.g., if an application is attempting to access a protected resource that it normally does not access).

The analysis component 112 determines whether the second object is stored in a local namespace. The security component 116 grants the request received by the interface component 110 if the second object is determined by the analysis component 112 to be stored in the local namespace. If the second object is determined by the analysis component 112 to be stored in the global namespace, the security component 116 checks the first object's access for a required access, such as read access, against the second object. If the access is denied, the request is also denied. Otherwise, if the access is granted, the second object is copied from the global namespace to the local namespace and grants the first object access to modify the copied second object in the local namespace. The enumeration component generates a list of objects available on the computing system by generating a list of the objects in all the namespaces (e.g., local and global) and removing any duplicated objects that are common to more than one list.

Providing Access Control Through Virtualizing Resources

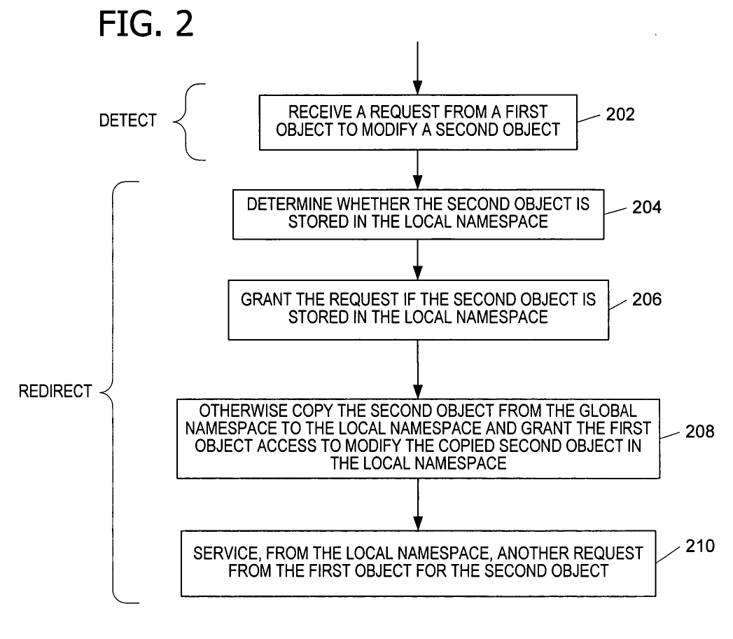

Referring next to FIG. 2, an exemplary flow chart illustrates operation of an access control method. In one embodiment, the invention grants an application program access to a resource on a computing system. The method includes receiving a request from a first object to modify a second object at 202 and determining whether the second object is stored in the local namespace at 204. The method grants the received request at 206 if the second object is determined to be stored in the local namespace. Otherwise, the method copies the second object from the global namespace to the local namespace, if the first object passes access checks on the second object, and grants the first object access to modify the copied second object in the local namespace at 208. For some embodiments, the operating system may utilize optimizations such as copy on write, or storing only the changes made to the object rather than the entire object data. Future requests for the second object are serviced from the local namespace at 210.

In one embodiment, an operating system executes the method illustrated in FIG. 2. In another embodiment, an application program or service separate from the operating system executes the method illustrated in FIG. 2. One or more computer-readable media have computer-executable instructions for performing the method illustrated in FIG. 2.

Exemplary Mitigation Architecture

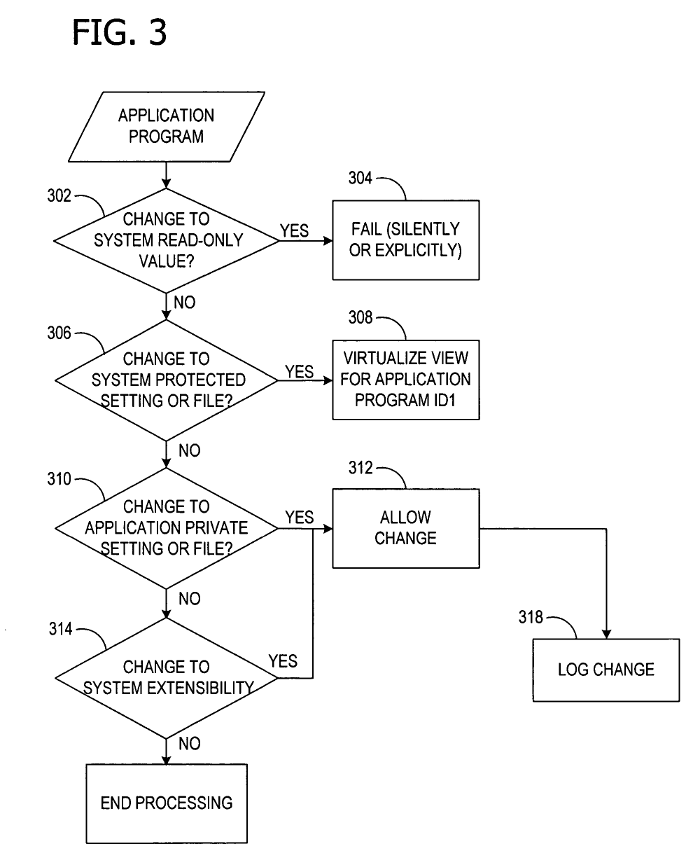

Referring next to FIG. 3, an exemplary flow chart illustrates a mitigation architecture for protecting various resources. In FIG. 3, an application program requests access to various resources. An embodiment of the invention receives the request. If the application program sends a request for read access to a operating system resource (e.g., a file or setting) with an access control list which specifies read-only for that application, an embodiment of the invention grants the application program read-only access to the resource. If the application program sends a request to modify one of these read-only resources at 302, an embodiment of the invention denies the application program access to the one resource. The request fails silently (e.g., no response returned to the application program) or explicitly (e.g., a negative response is returned to the application program) at 304.

The application program has access to other operating system resources at a protected privilege. If the application program sends a request to modify one of these protected operating system resources (e.g., settings or files) at 306, an embodiment of the invention determines whether a copy of the requested resource exists in a local namespace specific to the application program. If the copy exists, an embodiment of the invention returns the virtualized view of the protected resource for the application program at 308. If the copy of the requested resource does not already exist, an embodiment of the invention generates the copy in the local namespace for read-write access by the application program. In one embodiment in which a copy does not yet exist in the local namespace, a copy is not generated if the request from the application program is only for read access. For example, the operating system maintains its own copy of a system setting while an application program writing a value to the system setting receives its own copy of the system setting. In some exemplary embodiments, different applications may receive different virtualized views of system settings (e.g., registry entries). Depending on the type of system protection desired (e.g., by a user), a resource may be virtualized per user, per application program, and/or per session. Changes to a virtualized resource by an application program with a particular application identifier have no impact (e.g., are not visible) to other application programs. By providing individual applications or groups of applications with their own view of selected system resources, the operating system may prevent one application program from overwriting or otherwise disrupting resources needed by other application programs.

In one embodiment, an application program uses a virtualized copy of a resource during installation of the application program on a computing system. For example, the application program may apply a system setting to the computing system using a generated copy of the system setting.

The application program has access to application private resources (e.g., those files and settings associated with the application program). The operating system and other application programs are generally unaffected by application private resources. If the application program sends a request to modify an application private resource at 310, an embodiment of the invention allows and processes the request at 312.

The application program may send a request to change system extensibility (e.g., add functionality to the operating system) at 314. In one embodiment, an embodiment of the invention allows the requested change at 312.

Changes to system extensibility and application private resources (e.g., files and system settings) may be logged or otherwise recorded at 318. Generally, system extensibility changes provide additional functionality to the operating system without modifications to the operating system. Recording the system extensibility changes and changes to application private resources enables the rollback of the changes as well as the complete removal or uninstallation of the application program associated with the changes.

Example Mitigation Strategy

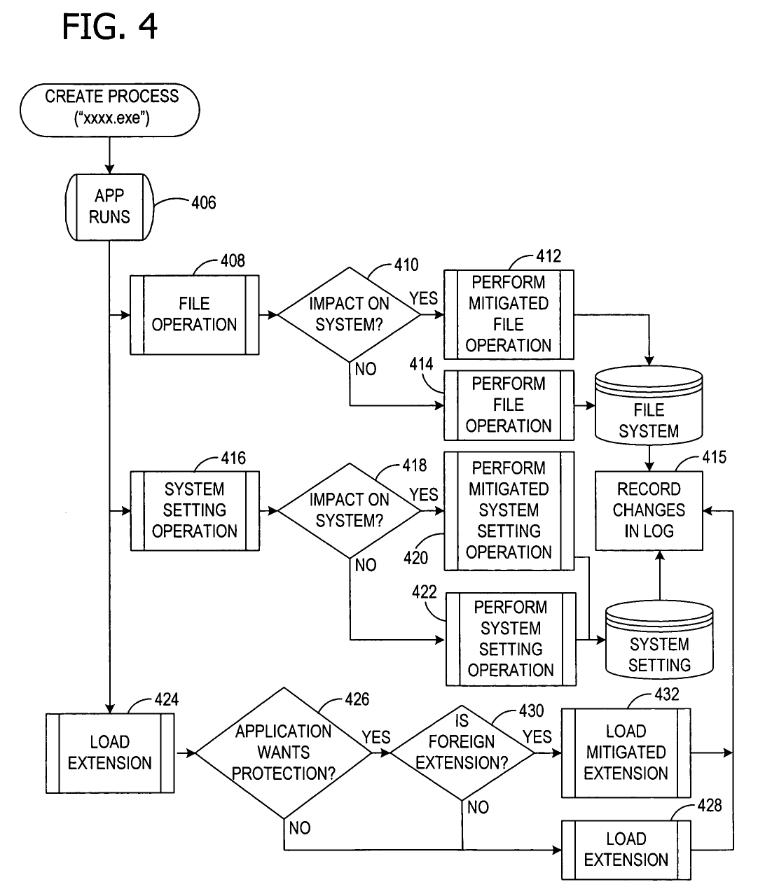

Referring next to FIG. 4, an exemplary flow chart illustrates operation of a method of providing access control for files, system settings, and extensions. In the example of FIG. 4, an operating system implements the method. However, an application program or service not associated with the operating system may also implement the method. In FIG. 4, a process is created to execute an application program (e.g., xxxx.exe) via a function such as CreateProcess( ). The application program executes at 406 and performs an operation. The operating system analyzes the operation.

In the embodiment of FIG. 4, if the operation is a file operation at 408, the operating system determines if the file operation will have an impact on a file (e.g., the file operation modifies the file) at 410. If the file operation will not have an impact on the file, the operating system allows the file operation to be performed on the file system at 414. If the file operation will have an impact on the file, the operating system performs a mitigated file operation at 412 according to a mitigation strategy such as illustrated in FIG. 3. The change to the file system, if any, is recorded in a log at 415.

If the operation is a system setting operation at 416, the operating system determines if the system setting operation will have an impact on a system setting (e.g., the system setting operation modifies the system setting) at 418. If the system setting operation will not have an impact on the system setting, the operating system allows the system setting operation to be performed on the system setting at 422. If the system setting operation will have an impact on the system setting, the operating system performs a mitigated system setting operation at 420 according to a mitigation strategy such as illustrated in FIG. 3. The change to the system setting, if any, is recorded in a log at 415.

If the operation represents a request to load an extension to the operating system at 424, the operating system determines if the application program (e.g., xxxx.exe) desires protection (e.g., to enable an “undo”) at 426. For example, the application program may explicitly inform the operating system of a desire for protection. If the application program does not want protection, the operating system allows the extension to load at 428. If the application program indicates that protection is desired, the operating system determines if the extension is a foreign extension (e.g., supplied by a third party) at 430. If the extension is not foreign, the operating system allows the extension to load at 428. If the extension is foreign, the operating system performs a mitigated extension load at 432 according to a mitigation strategy such as illustrated in FIG. 3. The extension load may be recorded in a log. For example, the recording may be configurable by a user of the computing system executing the operating system.

With virtualization, an application creates and modifies objects in their own local namespace, while the operating system creates and modifies objects in the global namespace. There is one global namespace, and potentially multiple local namespaces. For create operations, the application creates the object in its local namespace. When an application attempts to modify an object, the operating system checks if the object resides in the local namespace for the application. If the local object exists, the application opens the object in its local namespace. If the application attempts to modify an object in the global namespace, the operating system copies the object into the application's local namespace and allows the operation to occur on that local object. If the resource does not exist in the local or global namespace, the open operation fails.

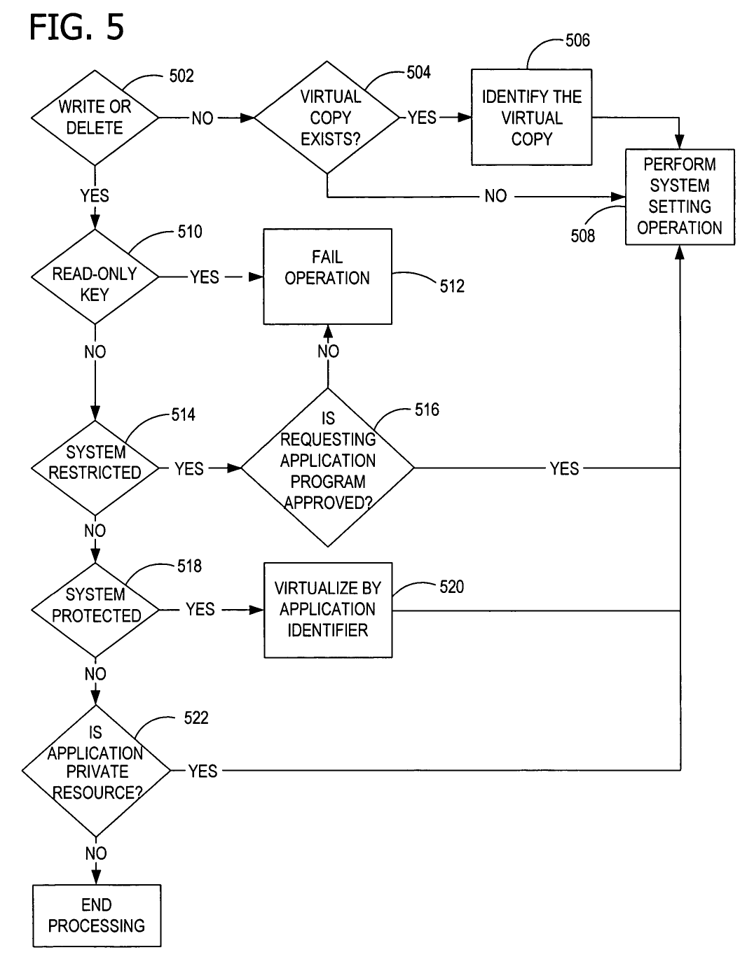

Referring next to FIG. 5, an exemplary flow chart illustrates operation of a method of providing access control for system settings. Even though FIG. 5 illustrates an example related to system settings, the virtualization aspect of the invention may be utilized for other objects (e.g., named objects) and namespaces. In FIG. 5, an embodiment of the invention such as an operating system analyzes an operation on a system setting requested by, for example, an application program. In particular, the operating system determines if the requested operation will write or delete a system setting at 502. If the requested operation will not write or delete a system setting (e.g., read-only access is requested), the operating system determines if a virtual copy of the system setting currently exists at 504. If a virtual copy exists, the operating system identifies the virtual copy at 506 and performs the requested operation on the virtual copy of the system setting at 508. If a virtual copy does not exist, the operating system performs the requested operation on the system setting at 508.

If the requested operation will write or delete a system setting, the operating system determines if the requesting application program is associated with a read-only key (e.g., the requesting application program is not a trusted installer) at 510. If the requesting application program is associated with read-only access (e.g., via an access control list maintained by the operating system), the operating system will fail or deny the requested operation at 512. If the requesting application program is not associated with a read-only access, the operating system determines if the requested operation will write or delete a system-restricted setting at 514. If the requested operation will write or delete a system restricted setting, the operating system determines if the requesting application program is approved to perform the operation at 516. For example, the operating system may determine if the requesting application program has administrator privileges on the computing system. If the requesting application program is approved to perform the operation, the operating system will perform the requested operation at 508. If the requesting application program is not approved to perform the operation, the operating system will fail or deny the requested operation at 512.

If the requested operation will not write or delete a system restricted setting, the operating system determines if the requested operation is for a protected setting (e.g., a copy of a system setting associated with the requesting application program) at 518. If the operating system determines that the requested operation is for a protected setting, the operating system virtualizes the protected setting by the application identifier of the requesting application program at 520. That is, the operating system identifies the virtual copy of the system setting and performs the requested operation on the identified, virtual copy of the system setting at 508. If the operating system determines that the requested operation is not for a protected setting, the operating system determines if the requested operation is for a private setting (e.g., a system setting associated with the requesting application program) at 522. If the operating system determines that the requested operation is for a private setting, the operating system performs the requested operation on the private system setting at 508. If the operating system determines that the requested operation is not for a private setting, the operating system ends processing and fails the request silently or explicitly.

When the application attempts to delete an object from the local namespace and a global object with the same name exists, the system marks the local object as deleted but leaves that object in the namespace. Thus, the system is able to detect that the application's queries for that object should not see that object's name. When the application attempts to delete an object that exists in the local namespace but not the global namespace, the system deletes the local object. Depending on the operating system configuration, deleting a global object may result in deleting all the corresponding local objects. In another embodiment, the system may allow the application to designate whether their corresponding objects should get deleted in this manner, and the resource provider stores that designation on the local object. Also, adding a global object may result in deleting all the corresponding objects marked as deleted from all local namespaces.

With this design, the application thinks that it is working in the global namespace, but in reality, it works in its own namespace. The system handles full path queries, enumerations, and other operations to make the application think that it is working in the global namespace. For example, namespace enumeration includes listing all files under a particular directory. The system queries all the objects in the specified namespace (e.g., starting first with the local namespace, then the global namespace). The system ignores duplicated objects with the global namespace enumeration found in the local namespace. Enumeration also ignores the objects marked as deleted from the local namespace and its corresponding global namespace object.

For applications that expect to share resources, the operating system may place the applications in the same virtualization application group (e.g., same isolation identity). Alternatively, the operating system may specify that a particular part of the namespace should not be virtualized. In yet another alternative, the applications specify a portion of their virtualized namespace that other applications may access. The client application specifies the applications for which access is desired. When the client application accesses a shared virtualized namespace, the operating system searches the corresponding exported namespace of the target applications.

Multiple Virtualization Layers

In some environments, the operating system may want to have multiple virtualization layers. There might be a virtualization layer per user and virtualization layer per application group. Various ordering of the multiple virtualization layers are within the scope of this invention. In this example, the user virtualization layer takes precedence over the application virtualization layer. Therefore, query requests and open requests for an object first check the current user's virtualization layers, then the current application group's virtualization layer, and finally the global namespace. The operating system returns the first object found or no object if the object does not exist in any of the virtualization layers or global namespace. Likewise for write operations, the operating system first opens the object. If the object exists in the highest precedence layer, then the write operation occurs on that object. If the object does not exist in the highest precedence layer, then the object gets copied into the highest precedence layer and the write operation occurs on the copied object. Create operations occur at the highest precedence layer, though operating systems in some embodiments may allow code to specify a particular virtualization layer as a preference.

Similarly, when deleting an object, the operation occurs at the highest precedence virtualization layer, though operating systems in some embodiments may allow code to specify a particular virtualization layer as a preference. Once the exact object is found, the operating system checks if the object exists in any applicable lower precedence namespace. If the object does exist in a lower precedence namespace, the intended delete object is mark as “deleted” and stays in its namespace. If the object does not exist in a lower precedence namespace, the object is deleted and removed from that namespace. In some configurations, the operating system may delete corresponding object from higher precedence namespaces. The creator of the higher precedence object, however, may designate the object to not be deleted in that case.

When adding an object to a lower precedence namespace, the operating system removes all corresponding objects marked as deleted from the higher precedence namespaces. The search and removal starts from the target namespace up to the next applicable higher precedence layer until the search finds a corresponding object that is not marked as deleted or has searched all the applicable layers. In other embodiments, adding an object to a lower precedence namespace will result in the search and removal of marked deleted objects from the higher precedence layers. Another embodiment may take no further actions when adding an object to a lower precedence namespace.

Enumeration operations account for all the applicable virtualization layers for the context and global namespace. The enumeration starts from the highest precedence applicable namespace and moves down to the global namespace. As the enumeration encounters an object marked as deleted, the enumeration for that object is ignored in lower precedence namespaces. The enumeration also ignores corresponding objects found previously in higher precedence namespaces. Several of the optimizations such as copy on write and storing only the difference data would also apply to the multiple layer virtualization.

Operating System Object Protection

The operating system creates various objects. Some of the objects are intended for access by applications and others (e.g., internal objects) are only accessible by operating system components. The operating system defines the access rights (e.g., open and read access) for the objects.

In one embodiment, internal operating system objects should only be accessible by internal operating system components. To prevent external code from accessing the internal objects, the operating system marks the internal object for access only by internal operating system components. The runtime objects, running as internal operating system code, get associated with the internal operating system identity. Therefore, when a runtime object attempts to access an internal object, the operating system checks if the runtime object is associated with the internal operating system identity. If the runtime object has the internal operating system identity, the operating system allows the access. Otherwise, the operating system implements appropriate action. Appropriate action may include rejecting the access, logging the access attempt, etc.

When an internal operating system component creates an object, the object is marked for access only by internal operating system components unless the creator specifically marks the object as available for external access. The operating system may mark internal objects offline using resource information from a store, manifest, configuration file, digital signature, etc.

Even though some middleware components may be integrated with, sold with or installed with the operating system, they should not access internal objects except for some special expectations that external applications are also allowed to access. The operating system in one embodiment would like the middleware components to stop using the special exception internal object and migrate over to external objects. To address this issue, the operating system associates a middleware application identity with the middleware components. The special exception internal objects are marked additionally with the deprecated attribute. When a middleware component accesses the deprecated object, the system responds with the appropriate action such as audit the access and/or block the access. The middleware deprecated resource detection may be applied more generally for deprecating external objects or other internal objects.

Exemplary Operating Environment

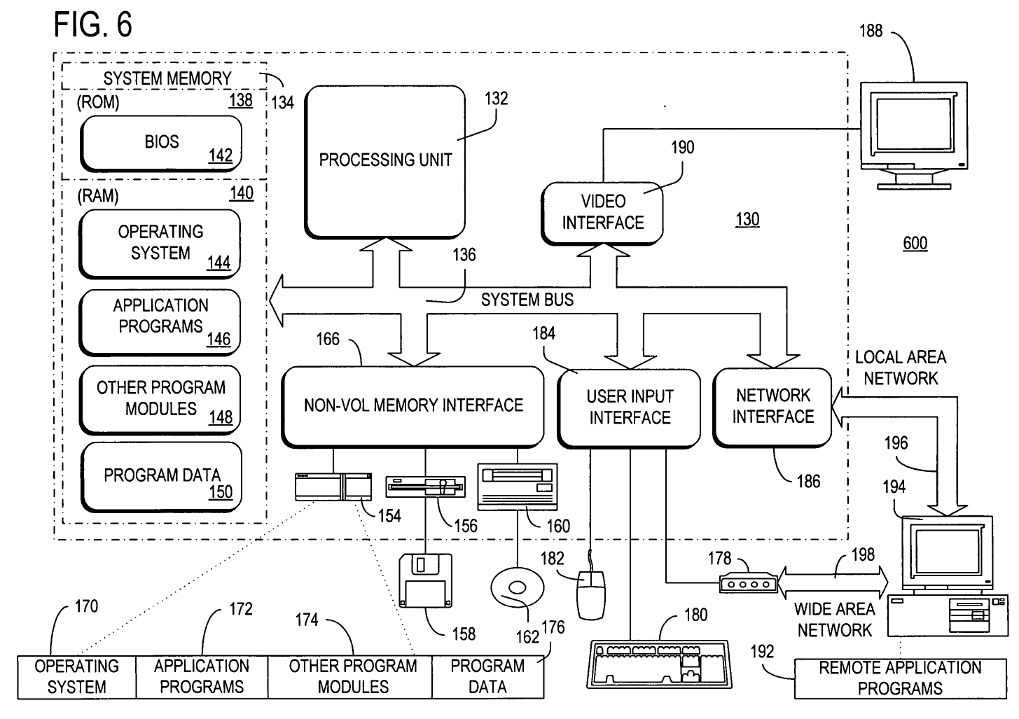

FIG. 6 shows one example of a general purpose computing device in the form of a computer 130. In one embodiment of the invention, a computer or other computing system such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 6 illustrates operating system 144, application programs 146, other program modules 148, and program data 150.

The computer 130 may also include other removable/non-removable, volatile/nonvolatile computer storage media. For example, FIG. 6 illustrates a hard disk drive 154 that reads from or writes to non-removable, nonvolatile magnetic media. FIG. 6 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 6, provide storage of computer readable instructions, data structures, program modules and other data for the computer 130. In FIG. 6, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 6 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 6 illustrates remote application programs 192 as residing on the memory device. The network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

In operation, computer 130 executes computer-executable instructions such as those illustrated in the figures to grant an application program access to a resource according to a privilege associated with the application program and with the resource. The systems and methods illustrated in the figures and described herein may be implemented in software or hardware or both using techniques some of which are well known in the art. Other implementations which directly implement embodiments of the invention through filters, hooks, or directly in the native resource provider are within the scope of the invention.

The order of execution or performance of the methods illustrated and described herein is not essential, unless otherwise specified. That is, elements of the methods may be performed in any order, unless otherwise specified, and that the methods may include more or less elements than those disclosed herein.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

1. A method of granting a first object executing in a computing system access to a second object, said first object having a local namespace associated therewith, said method comprising:
receiving a request from the first object to access the second object;
determining whether the second object is stored in the local namespace;
granting the first object access if the second object is determined to be stored in the local namespace; and
otherwise, copying the second object from a global namespace to the local namespace and granting the first object access to the copied second object in the local namespace.

2. The method of claim 1, further comprising:
receiving another request from the first object for the second object; and
granting the first object access to the copied second object.

3. The method of claim 1, wherein the second object has a protected status associated therewith, and further comprising:
denying the received request; and
sending an error message to the first object.

4. The method of claim 3, further comprising associating the protected status with the second object upon creation of the second object.

5. The method of claim 1, wherein the second object has a path associated therewith, and wherein granting the received request comprises modifying the path to point to the local namespace.

6. The method of claim 1, further comprising generating a list of objects available on the computing system.

7. The method of claim 6, wherein generating the list of objects comprises:
generating a first list of objects in the local namespace;
generating a second list of objects in the global namespace; and
removing any duplicate objects common to the first list and the second list.

8. The method of claim 1, wherein receiving the request comprises receiving a request from the first object to delete the second object, and wherein granting the received request comprises marking the second object in the local namespace as deleted.

9. The method of claim 1, further comprising receiving a notification that the second object has been deleted from the global namespace, and further comprising deleting the second object from the local namespace in response to the received notification.

10. The method of claim 1, further comprising logging the received request.

11. The method of claim 1, further comprising:
if the second object is determined to be stored in the global namespace and is identified as being external to the computing device, granting the first object access to modify the second object in the global namespace.

12. The method of claim 1, wherein one or more computer-readable media have computer-executable instructions for performing the method recited in claim 1.

13. One or more computer-readable media having computer-executable components for granting a first object executing in a computing system access to a second object, said first object having a local namespace associated therewith, said components comprising:
an interface component for receiving a request from the first object to access the second object;
an analysis component for determining whether the second object is stored in the local namespace;
a security component for granting the request received by the interface component if the second object is determined by the analysis component to be stored in the local namespace, and if the second object is determined by the analysis component to be stored in a global namespace, copying the second object from the global namespace to the local namespace and granting the first object access to the copied second object in the local namespace.

14. The computer-readable media of claim 13, further comprising an enumeration component for generating a list of objects available on the computing system by:
generating a first list of objects in the local namespace;
generating a second list of objects in the global namespace; and
removing any duplicate objects common to the first list and the second list.

15. The computer-readable media of claim 13, wherein the interface component receives a request from the first object to delete the second object from the local namespace, and wherein the security component marks the second object in the local namespace as deleted.

16. The computer-readable media of claim 13, wherein the security component comprises a logging component for storing information about the request received by the interface component in a log.

17. A system for multi-layer virtualization to protect objects in a computing system, said system comprising:
a memory area storing an ordered set of namespaces; and
a processor configured to execute computer-executable instructions for:
receiving a request from an executable object for access to a resource object;
identifying a first namespace from the ordered set of namespaces that includes the requested resource object; and
providing the executable object with access to the requested resource object from the identified, first namespace.

18. The system of claim 17, wherein the memory area stores the ordered set of namespaces including a user namespace, an application namespace, a session namespace, and a global namespace.

19. The system of claim 18, wherein the processor is further configured to execute computer-executable instructions for searching the user namespace, the application namespace, the session namespace, and the global namespace in order to locate the requested resource object.

20. The system of claim 17, wherein the computer-executable instructions are implemented in an operating system.

21. The system of claim 17, wherein the computer-executable instructions are supplied by a namespace provider.

22. The system of claim 17, further comprising a link between a resource object in a namespace in the ordered set of namespaces and another resource object in another namespace in the ordered set of namespaces.

23. The system of claim 17, wherein the link comprises one or more of the following: a file system link, a symbolic link, a soft link, a registry link, and a hard link.

24. A computerized method for deprecating resource usage in a computing system, said computerized method comprising:
detecting a predefined operation of an executable object, said predefined operation relating to access to a resource object;
redirecting the detected predefined operation from the resource object to another resource object as a function of the executable object and the resource object.

25. The computerized method of claim 24, wherein redirecting the detected predefined operation comprises redirecting the detected predefined operation from the resource object to the other resource object based on one or more of the following: a policy associated with the executable object, a policy associated with the resource object, a manifest associated with the executable object, a manifest associated with the resource object, an operating system manifest, a rule associated with the executable object, and a rule associated with the resource object.

26. The computerized method of claim 24, further comprising predefining the operation of the executable object.

27. The computerized method of claim 24, wherein redirecting the detected predefined operation comprises mapping the resource object to the other resource object.

28. The computerized method of claim 24, wherein the resource object is internal to an operating system of the computing system, and further comprising blocking execution of the detected predefined operation.

29. The computerized method of claim 28, further comprising sending an error message to the executable object.

30. The computerized method of claim 24, wherein the resource object is external to an operating system of the computing system, and further comprising allowing execution of the detected predefined operation.

31. The computerized method of claim 24, wherein the other resource object is associated with another executable object.

32. The computerized method of claim 24, wherein redirecting the detected predefined operation comprises redirecting the detected predefined operation from the resource object to the other resource object as a function of a session associated with the executable object.

33. The computerized method of claim 24, wherein redirecting the detected predefined operation comprises redirecting the detected predefined operation from the resource object to another resource object as a function of a manifest provided by a namespace provider.

34. The computerized method of claim 24, further comprising storing information relating to the detected predefined operation in a log file.

35. The computerized method of claim 24, wherein one or more computer-readable media have computer-executable instructions for performing the computerized method recited in claim 24.

36. A system for implementing a virtual view of computing system resources for an executable object, said system comprising:
a global namespace for storing one or more namespace objects;
a local namespace associated with the executable object, said local namespace for storing a copy of at least one of the one or more namespace objects; and
a manifest for mapping each of the namespace objects stored in the global namespace to the copy stored in the local namespace.

37. The system of claim 36, wherein the manifest comprises one or more of the following: a rule, an object manifest, and an operating system manifest.

38. The system of claim 36, wherein the namespace object comprises one or more of the following: a file, a folder, a process, a thread, a fiber, a work item, an operating system setting, a named object, an application programming interface, a code path, a library of executable routines, an operating system property value, and an operating system resource.

39. The system of claim 36, wherein the executable object comprises one or more of the following: an application program, a process, a thread, a fiber, a work item, an application programming interface, a code path, and a library of executable routines.
